(19) United States
(12) Patent Application Publication
(10) Pub. No.: US 2025/0341442 A1
(43) Pub. Date: Nov. 6, 2025

(54) METHODS AND SYSTEMS FOR SEALING EVALUATION OF INDUCTION-SEALED CONTAINERS

(71) Applicant: YORAN IMAGING LTD., Timrat (IL)

(72) Inventors: Yoav WEINSTEIN, Atlit (IL); Eran SINBAR, Misgav (IL)

(21) Appl. No.: 18/860,869

(22) PCT Filed: May 14, 2023
(86) PCT No.: PCT/IL2023/050496

§ 371 Date: Oct. 28, 2024

Related U.S. Application Data
(60) Provisional application No. 63/343,600, filed on May 19, 2022.

(51) Int. Cl. G01M 3/38; B65B 51/22; B65B 57/00; G01J 5/00; G01J 5/20; G06T 7/00; G06V 10/764

(52) U.S. Cl. CPC G01M 3/38; B65B 51/227; B65B 57/00; G01J 5/20; G06T 7/001; G06V 10/764; G01J 2005/0077; G06T 2207/10048; G06T 2207/20081; G06T 2207/30164; G06V 2201/06

(57) ABSTRACT

Method and system for determining sealing integrity and/or contamination of the sealing region by the filling material of a heat-sealed container, including imaging at least a part of a sealing region of the container using bolometer; wherein the imaging is performed during movement and/or transport of the container at a predetermined speed, and wherein the imaging is performed while moving the field of view of the bolometer in a same direction as the container, wherein the moving of the field of view is configured to reduce the velocity of the container relative to the imaging bolometer sufficiently to reduce smearing of images obtained.

### FIELD OF THE INVENTION

This invention relates to a method and system for thermal imaging of induction sealed containers, in particular for sealing evaluation of induction sealed containers within a package line.

### BACKGROUND OF THE INVENTION

The integrity of a packaged product is critical for maintaining product quality until it reaches the end user. Defects in hermeticity of a package may cause contamination, introduction of moisture, etc., which may result in loss of quality and even pose a safety hazard. It is therefore important to ensure the integrity of the packaged products at least at the end of their production process.

Induction sealing is the process of bonding thermoplastic materials by induction heating. This involves controlled heating an electrically conducting object (usually aluminum foil) by electromagnetic induction, through heat generated in the object by eddy currents.

Induction sealing is used in many types of manufacturing, in particularly in products required to be tamper proof. In packaging, it is used for package fabrication, such as forming tubes from flexible materials, attaching plastic closures to package forms, etc. Probably the most common use of induction sealing is cap sealing, a non-contact method of heating an inner seal to hermetically seal the top of plastic and glass containers. This sealing process takes place after the container has been filled and capped.

Typically, the closure is supplied to the bottler with an aluminum foil layer liner already inserted. Although there are various liners to choose from, a typical induction liner is multi-layered. The top layer is a paper pulp that is generally spot-glued to the cap. The next layer is wax that is used to bond a layer of aluminum foil to the pulp. The bottom layer is a polymer film laminated to the foil. After the cap or closure is applied, the container passes under an induction coil, which emits an oscillating electromagnetic field. As the container passes under the induction coil (sealing head) the conductive aluminum foil liner begins to heat due to eddy currents. The heat melts the wax, which is absorbed into the pulp backing and releases the foil from the cap. The polymer film also heats and flows onto the lip of the container. When cooled, the polymer creates a bond with the container resulting in a hermetically sealed product. Neither the container nor its contents are negatively affected, and the heat generated does not harm the contents.

However, inaccuracies in the packaging line may result in a compromised sealing of the container resulting in contamination, introduction of moisture, etc. into the container and its contents, which in turn may result in loss of quality and even pose a safety hazard to the consumer of the product. For example, overheating of the foil may cause damage to the seal layer and thus to the protective barriers. This might result in faulty seals, even weeks after the initial sealing process.

A reliable quality assurance of induction sealed containers is thus of uttermost importance. However, due to the fact that the container is capped by a lid, prior to the sealing renders such evaluation difficult and unreliable.

There therefore remains a need for a system and method allowing high-quality evaluation of sealing integrity of induction sealed containers.

### SUMMARY OF THE INVENTION

This present disclosure relates to a method and system for determining the sealing integrity of induction-sealed containers and/or to identify an operational defect responsible for a reduced sealing efficiency, using thermal imaging.

Complete and lasting sealing is a critical stage of most packaging processes, and sealing integrity needs to be inspected and/or tested in order to avoid messy leaks, costly product returns, damage to the product itself and/or damage to brand reputation. Packaging lines typically run at a fast pace, making traditional leak testing methods, such as a vacuum or pressure decay testing, or squeezing, too slow, too expensive and impractical. Moreover, these leak testing methods are based on statistical sampling and typically enable monitoring of the sealing process itself (i.e., temperature applied). Most often, these tests are incapable of detecting improper sealing during transport of the package along a package line.

Thermal imaging (also known, according to some embodiments, by the term “thermographic imaging”) is a type of infrared (IR) imaging in which radiation emitted from a substance is detected based on the temperature and emissivity at one or more locations across the substance (according to Black Body radiation law), and IR images are produced according to the detected temperatures and emissivity. Typically, the amount of radiation emitted by a substance increases with temperature. Therefore, thermography allows detecting variations in temperature and/or emissivity of a substance. For example, when viewed by a thermographic camera, warm objects can be differentiated from cooler backgrounds. Similarly, because of differences in emissivity, liquid based materials (including liquids, creams, pastes, foams, etc.) can be differentiated from dry products (e.g., the packaging material) using thermal imaging.

Thermal imaging of induction-sealed containers is challenging since the imaging must be made through the cap of the container.

Advantageously, it was found by the inventors of the present invention that imaging the induction seal, through a cap of the containers, such that the induction seal is imaged at an angle to a longitudinal or transverse axis of the container and/or cap, provides high-quality imaging sufficient for determining the integrity of the induction seal.

According to some embodiments, big data analysis may enable to alert in real time trends and apply preventive maintenance when needed, resulting in an increase of productivity and reduction of waste.

According to some embodiments, there is provided a packaging line comprising: a sealing station for induction sealing of containers; and a thermal detector operative at a wavelength in the range of about 0.3 μm-about 14 μm and configured to image the containers after sealing thereof, wherein the thermal detector is configured to image the induction seal of the sealed containers, through a cap of the containers, such that the induction seal is imaged at an angle to a longitudinal or transverse axis of the container and/or cap.

According to some embodiments, the packaging line comprises a second thermal detector, wherein the first and second thermal detectors are positioned such that the induction seal of the sealed containers is imaged at an angle to a longitudinal or transverse axis of the container and/or cap from opposite sides thereof.

According to some embodiments, the thermal detector is positioned above an upper cap of the containers. In this case the packaging line may include one or more optical elements positioned such that the induction seal is imaged at an angle to a longitudinal or transverse axis of the container and/or cap from opposite sides thereof. According to some embodiments, the optical element comprises an IR mirror. According to some embodiments, the IR mirror is a movable mirror.

According to some embodiments, the one or more optical elements may include at least two optical elements. According to some embodiments, the two or more optical elements may include 2, 3, 4, 5 or more optical elements. Each possibility is a separate embodiment. According to some embodiments, the two or more optical elements may include at least one side thermal camera configured to image the seal from a side of the container.

According to some embodiments, the packaging line includes a mechanism configured to rotate the sealed container, such that the induction seal is imaged at an angle to a longitudinal or transverse axis of the container and/or cap from opposite sides thereof.

According to some embodiments, the thermal detector is movable such that the induction seal is imaged at an angle to a longitudinal or transverse axis of the container and/or cap from opposite sides thereof.

According to some embodiments, the thermal detector is a bolometer or a semiconductor. According to some embodiments, the thermal detector comprises a Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. or any combination thereof.

According to some embodiments, the thermal detector is positioned at the sealing station. According to some embodiments, the thermal detector is positioned at a seal-integrity evaluation station, downstream the sealing station.

According to some embodiments, the packaging line according includes a filling station for filling the container with a filling material.

According to some embodiments, the induction seal comprises a backing layer, a foil and a heat seal layer.

According to some embodiments, the thermal detector is operative at a wavelength in the range of about 2 μm-about 14 μm. According to some embodiments, the thermal detector is operative at a wavelength in the range of about 8 μm-about 14 μm. According to some embodiments, the thermal detector is operative at a wavelength in the range of about 2 μm-about 6 μm.

According to some embodiments, the thermal detector may be configured to enable to evaluate whether the closure of the cap is proper/complete, for example by measuring the total height of the container or by measuring a distance between a part of the cap (e.g., its lower rim) to a predetermined point of the container (e.g., the bottom of the container)

According to some embodiments, the thermal detector may be configured to evaluate the content of the container, such as, but not limited to evaluating the degree/level of filling of the container and/or contaminations of the container by the filling material.

According to some embodiments, there is provided a packaging system comprising an imaging thermal detector operative at a wavelength in the range of about 0.3 μm-about 14 μm and configured to image the containers after sealing thereof, wherein the thermal detector is configured to image the induction seal of the sealed containers, through a cap of the containers, such that the induction seal is imaged at an angle to a longitudinal or transverse axis of the container and/or cap, and a processor configured to apply big data analysis on one or more images (e.g. 1, 2, 3 or more images) obtained from the imaging of the container to determine a sealing integrity of the container and/or to identify an operational defect responsible for a reduced sealing efficiency.

According to some embodiments, a processor may be configured to apply big data analysis on one or more images obtained from the imaging of the container to determine a trend in the induction sealing performance, and/or provide an indication regarding a detected and/or predicted induction sealing deficiency based thereon. According to some embodiments, big data analysis may include applying an artificial intelligence (AI) on one or more images obtained from the imaging of the container.

According to some embodiments, applying of the big data analysis comprises applying a machine learning algorithm. According to some embodiments, a machine learning algorithm may include an artificial intelligence (AI). According to some embodiments, the machine learning algorithm is trained on a data set comprising a large plurality of images and a large plurality of labels associated with the large plurality of images, the large plurality of labels indicating an integrity of the induction seal of the sealed containers. According to some embodiments, the data set comprises an indication regarding the cause of a reduced sealing efficiency associated with each of the large plurality of images having a compromised induction seal.

According to some embodiments, the packaging system comprises a user interface for reporting an operational problem and/or actions taken. According to some embodiments, the big data analysis comprises taking into account the reported actions. According to some embodiments, the big data analysis comprises taking into account the reported actions.

According to some embodiments, the detected and/or predicted induction sealing deficiency may be an operational defect selected from: missing induction seal or layer thereof, a defect in the induction seal, a bent induction seal or layer thereof, insufficient closing of the cap of the container, defect cap or lid thread, sealing region contamination, defect sealing region or any combination thereof.

According to some embodiments, the system may be configured to issue an alert if the number of sealing defect incidents exceeds a predetermined threshold value. According to some embodiments, the system may be configured to issue an alert if an operational defect is detected.

According to some embodiments, the system may be configured to halt operation of the packaging line if the number of sealing defect incidents exceeds a predetermined threshold value. According to some embodiments, the system may be configured to halt operation of the packaging line if an operational defect is detected.

According to some embodiments, the thermal detector is a bolometer or a semiconductor. According to some embodiments, the thermal detector comprises a Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. r or any combination thereof.

According to some embodiments, there is provided a method for determining sealing integrity of induction-sealed containers, the method comprising: imaging an induction container using a thermal detector operative at a wavelength in the range of about 0.3 μm-about 14 μm after sealing of the container by induction sealing, wherein the imaging comprises imaging the induction seal of the container, through a cap of the container, such that the induction seal is imaged at an angle to a longitudinal or transverse axis of the container and/or cap.

According to some embodiments, the method includes determining a sealing integrity of the container and/or to identifying an operational defect responsible for a reduced sealing efficiency by applying big data analysis on one or more images obtained from the imaging of the container. According to some embodiments, applying big data analysis may include applying an artificial intelligence (AI) on one or more images obtained from the imaging of the container.

According to some embodiments, the imaging comprises imaging the induction seal of the container from both sides of the induction seal. According to some embodiments, the imaging from both sides of the induction seal comprises utilizing at least two thermal detectors. According to some embodiments, the imaging from both sides of the induction seal comprises utilizing an optical element. According to some embodiments, the imaging from both sides of the induction seal comprises rotating the container during imaging thereof. According to some embodiments, the imaging from both sides of the induction seal comprises rotating a thermal detector. According to some embodiments, the imaging is performed after the sealing of the container has been completed.

According to some embodiments, the container is selected from the group consisting of a canister, a blister package, a tube, a heat seal bag, a pouch, a sachet, a bottle, or any combination thereof. Each possibility is a separate embodiment.

According to some embodiments, the thermal detector is a bolometer or a semiconductor. According to some embodiments, the thermal detector comprises a Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. or any combination thereof.

According to some embodiments, the method may include the following steps:
Thermal inspection of integrity of induction sealed containers using one or more thermal detectors, as essentially described herein. Preferably all containers are imaged.
If the technical data is indicative of an operational defect and/or inaccuracy, an alert is issued and/or the operation of the packaging line halted and a recommendation regarding managing the operational problem may optionally be issued.
Similarly, if the imaging of the containers identifies a large number of defected containers (above a predetermined threshold) are observed within a given period of time an alert is issued and/or the operation of the packaging line halted, and a recommendation regarding managing of the operational problem may optionally be issued.
Moreover, if package line technician and/or manager reports an operational problem and/or if the number of reported problems exceeds a predetermined threshold over a given period of time an alert is issued and/or the operation of the packaging line halted, and a recommendation regarding managing of the operational problem may optionally be issued.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIGS. 1A and 1B: Schematically illustrates a side view and a front view, respectively of a packaging line 100 for monitoring sealing integrity of an induction-sealed container and/or for identifying an operational defect responsible for a reduced sealing efficiency using a (one) thermal camera and optical elements, according to some embodiments;

FIG. 2: Schematically illustrates side and front views of a packaging line 100 for monitoring sealing integrity of an induction-sealed container and/or for identifying an operational defect responsible for a reduced sealing efficiency using two thermal cameras, according to some embodiments;

FIG. 3: Schematically illustrates side and front views of a packaging line 300 for monitoring sealing integrity of an induction-sealed container and/or for identifying an operational defect responsible for a reduced sealing efficiency using two thermal cameras, according to some embodiments;

FIG. 4A: A representative picture of a sealing region of an induction-sealed container obtained when imaging the induction seal through the cap of the container from above;

FIG. 4B: A representative picture of a sealing region of an induction-sealed container obtained when imaging the induction seal through the cap of the container from the side thereof;

FIG. 4C: A representative picture of an induction-sealed container with a compromised and/or defective induction seal (due to a folded laminate) as visible when imaging the induction seal through the cap of the container from the side thereof;

FIG. 4D: A representative picture of an induction-sealed container with a compromised and/or defective induction seal (due to insufficient heating) as visible when imaging the induction seal through the cap of the container from the side thereof;

FIG. 4E: A representative picture of an induction-sealed container with a compromised and/or defective induction seal (due to lack of laminate) as visible when imaging the induction seal through the cap of the container from the side thereof;

FIG. 5A: Representative pictures of an induction-sealed container with a compromised and/or defective induction seal (unsealed laminates due to non-horizontally torqued cap) as visible when imaging the induction seal through the cap of the container from the side thereof;

FIG. 5B: Representative pictures of an induction-sealed container without a compromised and/or defective induction seal (sealed laminates due to horizontally torqued cap) as visible when imaging the induction seal through the cap of the container from the side thereof;

FIG. 6A: Representative pictures of an induction-sealed container with a compromised and/or defective induction seal (unsealed laminates due to non-horizontally torqued cap) as visible by cap height monitoring by thermal imaging of a cap and container from the side thereof;

FIG. 6B: Representative pictures of an induction-sealed container without a compromised and/or defective induction seal (sealed laminates due to horizontally torqued cap) as visible by cap height monitoring by thermal imaging of a cap and container from the side thereof;

FIG. 7: A chart of side thermal camera statistical process controls results from thermal cap monitoring, according to some embodiments;

FIG. 8A: Representative pictures of an induction-sealed container with a compromised and/or defective induction seal (due to lack of laminate) as visible when imaging the induction seal through the cap of the container from the side thereof;

FIG. 8B: Representative pictures of an induction-sealed container with a compromised and/or defective induction seal (due to lack of laminate) as visible when imaging the induction seal through the cap of the container from the side thereof; and

FIG. 9: A chart of side thermal camera statistical process controls results from thermal cap monitoring, according to some embodiments.

### DETAILED DESCRIPTION OF THE INVENTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

As used herein, according to some embodiments, the term “induction sealing” refers to a process of bonding thermoplastic materials by induction heating. This involves controlled heating an electrically conducting object (usually aluminum foil) by electromagnetic induction, through heat generated in the object by eddy currents.

According to some embodiments, the object is container. As used herein, according to some embodiments, the terms “container” and “package” may be used interchangeably and refer to any packaging means suitable for containing a filling material and sized and shaped to enable filling and sealing on a package line.

According to some embodiments, the container may be a primary container, i.e., the package that first envelops the product and holds it. According to some embodiments, a container may be selected from the group consisting of a canister, a blister package, a tube, a heat seal bag, pouch, sachet, capsule, tablet, bottle, box, or any combination thereof. Each possibility is a separate embodiment.

Non-limiting examples of suitable containers include canisters (such as, but not limited to, lunch meats, cheeses, spreads, yogurt, canisters containing cosmetic products, and the like), blister packages (such as, but not limited to, blisters used for packaging of medical equipment, medicaments, batteries, and more), tubes (such as, but not limited to, toothpaste tubes or cosmetic tubes), heat seal bags or sachets (such as, but not limited to, heat sealed bag used for food packing, for packing of medical equipment, and the like) or any combination thereof. Each possibility is a separate embodiment. According to some embodiments, the container is a tablet containing bottle. According to some embodiments, the container is composed, at least in part, of polyethylene (PE), low-density polyethylene (LDPE), high-density polyethylene (HDPE), polyethylene terephthalate (PET), polyvinyl chloride (PVC), polypropylene, glass, polystyrene, rubber-modified polystyrene, acrylonitrile butadiene styrene, polyether ether ketone, poly (methyl methacrylate), paper, cardboard, etc. or any combination thereof. Each possibility is a separate embodiment. Optionally, the container may include a liner, such as polyethylene, aluminum, etc.

According to some embodiments, the imaging may be performed on at least part of a sealing region of a container and at least one parameter related to the quality of the container may refer to a sealing efficiency of the container. As used herein, according to some embodiments, the term “sealing region” refers to part of the container, which, after filling of the package, is configured to ensure its sealing.

As used herein, according to some embodiments, the term “cap” and “lid” are used interchangeably and relate to a removable cover for the opening of a hollow container. As used herein, according to some embodiments, the term “capping” relates to closing or covering the top or end of a container with a cap.

According to some embodiments, a cap may be a screw top with a thread, flip top lid, sports cap, cork stoppers, metal bottle cap, spray top, wadded lid, snap cap, ribbed lid, child-resistant closure, press-on closures, tamper-proof seal, tear-off cap, etc. According to some embodiments, a cap may be composed, at least in part, from polyethylene, polypropylene, steel, aluminum, etc. or a combination thereof. Each possibility is a separate embodiment.

According to some embodiments, the cap may include an induction seal. According to some embodiments, the induction seal includes a backing layer, a foil and a heat seal layer. According to some embodiments, the backing layer may be composed of a paper pulp, polystyrene, foam, etc. According to some embodiments, the foil may be a lightweight metal layer, e.g., aluminum foil, etc. According to some embodiments, the heat seal layer may be composed of wax, a polymer film (e.g., polyurethane, polyester, etc.) or a combination thereof. According to some embodiments, the induction seal may hermetically seal the container.

According to some embodiments, the term “sealing efficiency” may refer to the integrity of the sealed container, i.e., its ability to prevent filling material contained therein to leak out and/or from getting contaminated. According to some embodiments, the sealing efficiency may be evaluated after the sealing of the container has been completed.

As used herein, according to some embodiments, the term “filling material” refers to the product filled in/contained within the container. According to some embodiments, the filling material may be a solid, a semi-solid, a liquid, a paste, a cream, a foam, a tablet, a capsule, a gas, or any combination thereof. Each possibility is a separate embodiment. According to some embodiments, the filling material may be colorless, transparent, white, cream-colored, light-pink colored or have a color similar to the color of at least the sealing region of the container. Each possibility is a separate embodiment.

According to some embodiments, movement and/or transport of the object may refer to passive and active change of the object's position. According to some embodiments, the movement and/or transport of the object (e.g., the container) may refer to the object being transported along a packaging line e.g., due to it being placed on a moving rail, wheeled conveyor, etc. According to some embodiments, the movement and/or transport of the object (e.g., the container) may refer to a sealed package exiting a heat sealing station of a packaging line.

According to some embodiments, a “moving object” may refer to an object (e.g., container) moved at a predetermined speed, the speed causing the thermal imaging of the object to smear. According to some embodiments, the predetermined speed of the object (e.g., container) may be a speed too high to enable thermal relaxation of a thermal camera's bolometer. According to some embodiments, the predetermined speed of the object may be in the range of 200 mm/sec-2,000 mm/sec. According to some embodiments, the packaging line may include a mechanism configured to rotate a sealed container, such that the induction seal can be imaged at an angle to a longitudinal or transverse axis of the container and/or cap.

According to some embodiments, determining at least one parameter related to the quality of the object (e.g., sealing efficiency) includes processing of images obtained during the imaging. According to some embodiments, the imaging may include obtaining at least two images of the object. As used herein, according to some embodiments, the term “at least two”, when referring to the images obtained during imaging may refer to 2, 3, 4, 5 or more images. Each possibility is a separate embodiment.

According to some embodiments, image processing may include applying image processing algorithms. According to some embodiments, the image processing may include image contrast analysis, edge detection, image arithmetic, cross correlation between images, convolution between images or between an image to a predefined kernel, spatial frequency transformation and/or spatial filtering methods, temporal frequency transformation and temporal filtering methods, Fourier transforms, discrete Fourier transforms, discrete cosine transforms, morphological image processing, finding peaks and valleys (low and high intensity areas), image contours recognition, boundary tracing, line detection, texture analysis, histogram equalization, image deblurring, cluster analysis or any other suitable image processing known in the art, or combinations thereof. Each possibility is a separate embodiment. According to some embodiments, the image processing may include applying an artificial intelligence.

According to some embodiments, the identification of a low-quality object may result in halting further processing of the object. As a non-limiting example, identification of a container with improper sealing may results in its ejection from the packaging line, in arrest of the packaging process, or any other suitable action required to prevent an improperly sealed container from being discharged for distribution.

According to some embodiments, the method may include identifying trends indicative of and/or responsible for the reduced quality of the sealing. According to some embodiments, the method may include issuing an alert if an identified trend is indicative of a detected and/or predicted reduced quality of the sealing. According to some embodiments, the method may include recommendations on correcting an identified trend indicative of a detected and/or predicted reduced quality of the sealing. According to some embodiments, the method may include conducting a follow up inspection, wherein the follow up may take into account actions taken to overcome the detected and/or predicted reduced quality of the sealing. According to some embodiments, the method may include applying big data analysis in the identification of trends indicative of and/or responsible for the reduced quality of the sealing. According to some embodiments, the applying big data analysis in the identification of trends indicative of and/or responsible for the reduced quality of the sealing may include applying an artificial intelligence.

According to some embodiments, the imaging may at least be performed immediately after completion of the sealing of the container. According to some embodiments, the imaging may be performed using one or more thermal cameras, such as one, two, three, four or more thermal cameras. Each possibility is a separate embodiment. According to some embodiments, one or more thermal cameras may be movable. According to some embodiments, one or more thermal cameras may be rotatable.

According to some embodiments, the imaging comprises imaging the induction seal of the container from one or more sides of the induction seal, e.g., from the side of a packaging line, from above the packaging line, etc., or a combination thereof. According to some embodiments, the imaging from one or more sides of the induction seal may include utilizing one or more thermal detectors. According to some embodiments, the imaging from one or more sides of the induction seal may include utilizing an optical element. According to some embodiments, the imaging from one or more sides of the induction seal may include rotating the container during imaging thereof. According to some embodiments, the imaging from one or more sides of the induction seal may include rotating one or more thermal detectors.

According to some embodiments, the imaging from one or more sides of the induction seal may include adjusting the height of the one or more thermal detectors. According to some embodiments, adjusting the height of the one or more thermal detectors may be accommodate the height of the container, e.g., the thermal detector and/or optical element may be configured to be in line with and/or close to the cap of the container, the thermal detector and/or optical element may be configured to have a point on and/or in the cap as the focal point, etc. According to some embodiments, the preferred distance of a thermal detector and/or optical element from and/or height above the cap may be between about 1 mm to about 1 cm, between about 1 cm to about 5 cm, between about 5 cm to about 10 cm, or between about 10 cm to about 100 cm. Each possibility is a separate embodiment.

According to some embodiments, the imaging may be infra-red (IR) imaging. According to some embodiments, the imaging may be thermal imaging. According to some embodiments, the imaging may be medium wave infra-red (MWIR) imaging. According to some embodiments, the imaging may be long wave infra-red (LWIR) imaging. According to some embodiments, the imaging is performed at a wavelength in the range between about 0.3 μm to about 14 μm, between about 1 μm to about 3 μm, between about 3 μm to about 5 μm, between about 5 μm to about 8 μm, between about 8 μm to about 10 μm, or between about 12 μm to about μm. Each possibility is a separate embodiment. According to some embodiments, the imaging may be LWIR imaging. According to some embodiments, the imaging is performed at a wavelength in the range of about 8 μm-about 14 μm. According to some embodiments, the imaging may be MWIR imaging. According to some embodiments, the imaging is performed at a wavelength in the range of about 2 μm-about 6 μm. According to some embodiments, the IR imaging may be short wave-imaging, medium wave imaging, long wave imaging, or combinations thereof. Each possibility is a separate embodiment. As a non-limiting example, imaging may include obtaining images (one or more) in the short-wave spectrum, images (one or more) in the medium wave spectrum and/or images (one or more) in the long wave spectrum (one or more) of the same container.

According to some embodiments, the IR imaging may be performed at a wavelength in the range of about 2 μm-about 14 μm; about 3 μm-about 5.4 μm; about 1 μm-about 3 μm; about 0.9 μm-about 1.7 μm, or any combination thereof. Each possibility is a separate embodiment.

As a non-limiting example, the imaging of a container may include obtaining frames in each of or some of the aforementioned wavelength ranges. According to some embodiments, the imaging may be performed utilizing a Vanadium Oxide, VOx bolometer uncooled IR camera.

According to some embodiments, a thermal detector may be operative at a wavelength in the range of about 0.3 μm-about 14 μm. According to some embodiments, a thermal detector may be configured to image the containers after sealing thereof. According to some embodiments, a thermal detector may be configured to image the induction seal of the sealed containers, through a cap of the containers, such that the induction seal is imaged at an angle to a longitudinal or transverse axis of the container and/or cap.

According to some embodiments, the packaging line may include one or more thermal detectors. According to some embodiments, thermal detectors may be positioned such that the induction seal of the sealed containers is imaged at one or more angles to a longitudinal or transverse axis of the container and/or cap e.g., from opposite sides thereof, from above, etc.

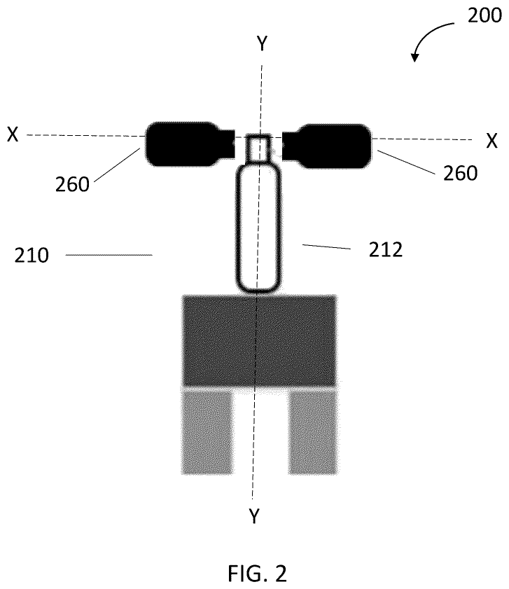

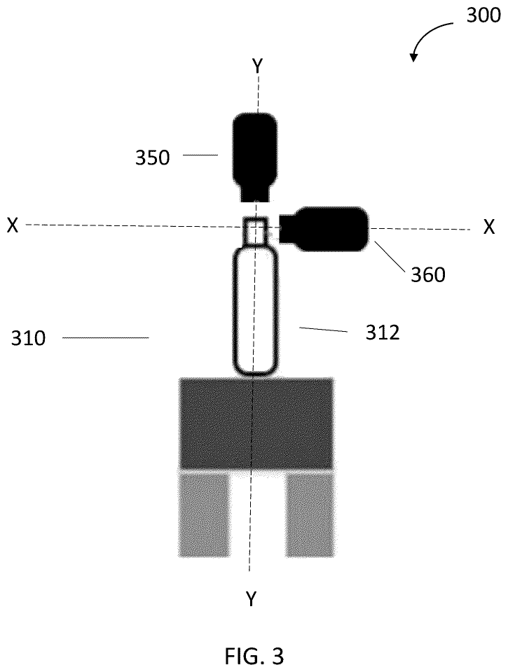

According to some embodiments, thermal detectors may be positioned at an angle of between about 1° to about 180°, between about 5° to about 120°, between about 15° to about 90°, between about 30° to about 60°, or between about 40° to about 50° to a longitudinal (e.g., FIGS. 2 and 3, axis Y-Y) or transverse axis (e.g., FIGS. 2 and 3, axis X-X) of a container and/or cap and/or a combination thereof. Each possibility is a separate embodiment.

According to some embodiments, thermal detectors may be positioned at an angle of between about 1° to about 180°, between about 5° to about 120°, between about 15° to about 90°, between about 30° to about 60°, or between about 40° to about 50° to each other. Each possibility is a separate embodiment.

According to some embodiments, thermal detectors may be positioned at an angle of between about 1° to about 180°, between about 5° to about 120°, between about 15° to about 90°, between about 30° to about 60°, or between about 40° to about 50° to a longitudinal or transverse axis of the container and/or cap. Each possibility is a separate embodiment. It is understood, according to some embodiments, that the term “at an angle to a longitudinal or transverse axis of the container and/or cap” may refer to imaging the induction seal from any angle on the side thereof and/or from any angle above.

According to some embodiments, the thermal detector may be movable such that the induction seal is imaged at an angle essentially perpendicular to the plane of the induction seal.

As used herein, according to some embodiments, the term “longitudinal axis” of the container (Y-Y axis) may relate to an axis of a container and/or cap perpendicular to the transverse axis, (X-X axis), e.g., through a long axis the container, through the center of the short axis of a container and/or cap, an angle essentially perpendicular to the plane of the induction seal, etc.

According to some embodiments, the thermal detectors may be movable. According to some embodiments, the thermal detectors may be rotatable. According to some embodiments, the thermal detector is movable such that the induction seal is imaged at an angle to at an angle to a longitudinal or transverse axis of the container and/or cap, e.g., from opposite sides thereof, from above, etc. According to some embodiments, a thermal detector may be positioned at a sealing station. According to some embodiments, the thermal detector may be positioned at a seal-integrity evaluation station, optionally, downstream of a sealing station.

According to some embodiments, the thermal detector may be a bolometer or a semiconductor. Non-limiting examples of thermal detectors are Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. Optionally, thermal detector may be uncooled. Optionally, a thermal detector may be actively cooled to increase sensitivity.

As used herein, according to some embodiments, the “frame rate” of infrared thermal imager relates to how many pictures can be output per unit time in the video process. The number of output pictures only represents the output time density. For example, 30 Hz represents 30 pictures output per second and 60 Hz represents 60 pictures output per second, etc. According to some embodiments, the frame rate of the thermal imaging may be between about 1 Hz to about 10 Hz, between about 10 Hz to about 50 Hz, between about 50 Hz to about 100 Hz, between about 100 Hz to about 500 Hz, between about 500 Hz to about 1,000 Hz. Each embodiment is a separate embodiment.

According to some embodiments, the frame rate of the thermal imaging may correspond to the speed of the packaging line, a pre-selected speed, a processing rate, etc. or a combination thereof. According to some embodiments, the frame rate of the thermal imaging may be between about 1 frame per container to about 5 frames per container, between about 5 frames per container to 10 frames per container, between about 10 frame per container to about 100 frames per container. Each possibility is a separate embodiment.

According to some embodiments, the thermal detector may be positioned above the cap of a container. According to some embodiments, the thermal detector may be positioned parallel to the cap of a container (e.g., transverse to a vertical axis of a container). According to some embodiments, the packaging line may include one or more optical elements positioned such that the induction seal is imaged at an angle to at an angle to a longitudinal or transverse axis of the container and/or cap, e.g., from opposite sides thereof, from above, at an angle of between about 30° to about 60°.

According to some embodiments, one or more thermal detectors may receive one or more images directly from the one or more thermal cameras and/or one or more complementary images from the one or more optical elements. According to some embodiments, an optical element may be positioned at an angle of between about 15° to about 90°, between about 30° to about 60°, or between about 40° to about 50° to a vertical axis of a container. Each possibility is a separate embodiment. For example, the packaging line may include one thermal camera from above and a side mirror at a 45° angle, two thermal cameras at angles to each other, etc.

According to some embodiments, the optical elements may include an IR mirror. According to some embodiments, the IR mirror may be a movable mirror. According to some embodiments, the IR mirror may be a rotatable mirror. According to some embodiments, the method includes evaluating sealing integrity, based on an integrated analysis of pre-sealing and post-sealing imaging.

As used herein, according to some embodiments, the term “integrated analysis” may refer to image processing, including applying processing algorithms to at least one image, applying processing algorithms to pre-sealing and post-sealing images, identifying improper sealing based on image parameters deduced from at least one image, and identifying improper sealing based on image parameters deduced from at least one pre-sealing image and at least one post-sealing image.

According to some embodiments, the image parameters may include relative intensities of one or more regions of one or more images, one or more measurable parameters (e.g., brightness, intensity, location, cap height, cap angle, etc.), comparison to one or more pre-determined parameters, etc.

According to some embodiments, the packaging line may include a processor configured to identify parameters based on data obtained from one or more thermal cameras. According to some embodiments, the processor unit may be an integral part of the packaging line. According to some embodiments, the processor may be external and/or adjunct to the packaging line, such as, but not limited to, a mobile, smartphone, tablet, desktop computer, laptop computer, VR device, and/or any dedicated computing device. Each possibility is a separate embodiment. According to some embodiments, the processor may be a virtual processor, such as an internet enabled device (i.e., cloud computing).

According to some embodiments, the processor may be configured to monitor and/or identify issues, trends and/or predict potential problems (e.g., failure) in the sealing process, e.g., applying processing algorithms on the data obtained from one or more thermal cameras.

According to some embodiments, a processor may be configured to identify issues, trends and/or predict potential issues in the sealing process, based on an integrated analysis of data obtained from one or more thermal cameras. According to some embodiments, the integrated analysis may include applying processing algorithms to data obtained from the one or more thermal cameras and identifying issues, trends and/or predict potential issues in the sealing process, based on parameters deduced and/or extrapolated from at least one data signal (e.g., image) obtained from each of the one or more thermal cameras.

According to some embodiments, the system and/or method may be configured to identify trends indicative of and/or responsible for an inefficient sealing process, such as, but not limited to, inaccurate inlet position, speed of packing line movement, heat of filing material, viscosity, and the like. According to some embodiments, the identifying of trends may include big data analysis and/or machine learning techniques, e.g., deep learning, artificial intelligence (AI), etc. According to some embodiments, when a defective trend is identified, the packaging line may be halted for inspection, calibration, repair, synchronization, cleaning, maintenance and/or the like, thereby preventing defective catastrophic failure.

According to some embodiments, a processor may be configured to apply big data analysis on one or more images obtained from the imaging of the container to determine a trend in the induction sealing performance, and/or provide an indication regarding a detected and/or predicted induction sealing deficiency based thereon.

According to some embodiments, the detected and/or predicted induction sealing deficiency may be an operational defect selected from: missing induction seal or layer thereof, a defect in the induction seal, a bent induction seal or layer thereof, insufficient closing of the cap of the container, defect cap or lid thread, sealing region contamination, defect sealing region or any combination thereof.

According to some embodiments, big data analysis may be applied to image data from one or more thermal cameras. According to some embodiments, applying of the big data analysis may include applying a machine learning algorithm. According to some embodiments, a machine learning algorithm may include an artificial intelligence (AI). According to some embodiments, the machine learning algorithm may be trained on a data set comprising a large plurality of images and a large plurality of labels associated with the large plurality of images, the large plurality of labels indicating an integrity of the induction seal of the sealed containers. According to some embodiments, the data set may include an indication regarding a cause of a reduced sealing efficiency associated with each of the large plurality of images having a compromised induction seal, e.g., an operational defect such as a missing induction seal or layer thereof, a defect in the induction seal, a bent induction seal or layer thereof, insufficient closing of the cap of the container, defect lid thread, sealing region contamination, defect sealing region or any combination thereof.

According to some embodiments, a user may report actions taken to prevent, correct or reduce operational defects e.g., through a user interface, etc. According to some embodiments, the big data analysis may take into account the user reported action.

According to some embodiments, the method includes squeezing or otherwise applying pressure on the container, prior to the post-sealing imaging. Squeezing the container will, in the case of incomplete sealing, result in small amounts of filler material to leak out of the container. Advantageously, thermal imaging of the container allows the detection of such leaks, and thus improper sealing of the container due to its high sensitivity to differences in the emissivity of a product and its low sensitivity to reflections. Specifically, thermal infra-red imaging (e.g., utilizing a Vanadium Oxide, VOx bolometer uncooled IR camera), is primarily based on radiation (as compared to reflection) and is therefore sensitive to differences in emissivity. As a result, its sensitivity to leakages is much higher than standard visual imaging (e.g., utilizing CCD based cameras).

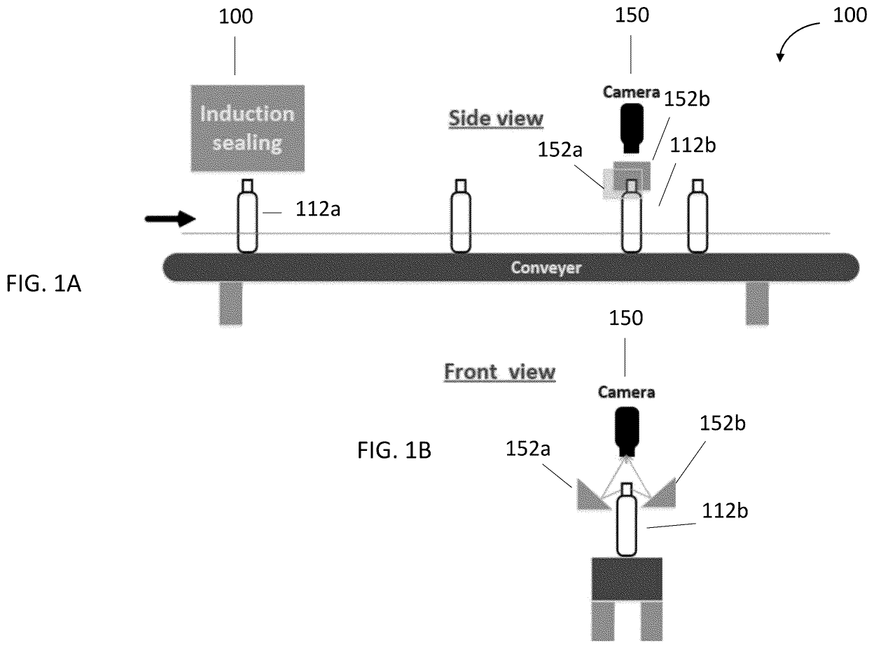

Reference is now made to FIGS. 1A and 1B, which schematically illustrates a side view and a front view, respectively of a packaging line 100 for monitoring sealing integrity of an induction-sealed container and/or for identifying an operational defect responsible for a reduced sealing efficiency, according to some embodiments.

Packaging line 100 includes a sealing station 110 at which containers, such as container 112a, are hermetically sealed using induction sealing, as essentially known in the art. Packaging line 100 includes a thermal camera 150 and optical elements 152a and 152b configured to image the containers (such as container 112b) as they move along a conveyor of the packaging line. Thermal camera 150 and optical elements 152a and 152b are positioned such that the induction seal is imaged at an angle to a longitudinal axis of the cap (e.g., Y-Y). It is understood, according to some embodiments, that the term angle to the a longitudinal axis of the container or the cap refers to imaging the induction seal from the side thereof and does not necessarily require a 90° angle.

Reference is now made to FIG. 2, which schematically illustrates a front view of a packaging line 200 with monitoring sealing integrity capability of induction-sealed containers and/or for identifying operational defects responsible for a reduced sealing efficiency, according to some embodiments.

Packaging line 200 includes a sealing station 210 at which containers, such as container 212, are hermetically sealed using induction sealing, as essentially known in the art. Packaging line 200 includes thermal cameras 250 and 260, positioned on opposite side of a packaging line to allow imaging of the induction seal of container 212 at an angle to a longitudinal (e.g., Y-Y) or transverse axis (e.g., X-X) of the container or the cap.

According to some embodiments, the imaging from one or more sides of the induction seal may include adjusting the height of the one or more thermal detectors. According to some embodiments, adjusting the height of the one or more thermal detectors may be accommodate the height of the container, e.g., the thermal detector and/or optical element may be configured to be in line with and/or close to the cap of the container, the thermal detector and/or optical element may be configured to have a point on and/or in the cap as the focal point, etc.

According to some embodiments, the imaging from one or more sides of the induction seal may include rotating the container during imaging thereof. According to some embodiments, the imaging from one or more sides of the induction seal may include rotating one or more thermal detectors and/or optical elements.

Reference is now made to FIG. 3, which schematically illustrates a front view of a packaging line 300 with monitoring sealing integrity capability of induction-sealed containers and/or for identifying operational defects responsible for a reduced sealing efficiency, according to some embodiments.

Packaging line 300 includes a sealing station 310 at which containers, such as container 312, are hermetically sealed using induction sealing, as essentially known in the art. Packaging line 300 includes thermal cameras 350 and 360, positioned with one thermal camera above the packaging line 350 and one thermal camera on the side of the packaging line 360, to allow imaging of the induction seal of container 312 at an angle to a longitudinal or transverse axis of the container and/or cap.

### EXAMPLES

### Example 1—Comparative Study of Thermal Imaging of Induction Sealed Containers Through the Top or Through the Side of the Cap

In the thermal images, white represents hot and black represents cold.

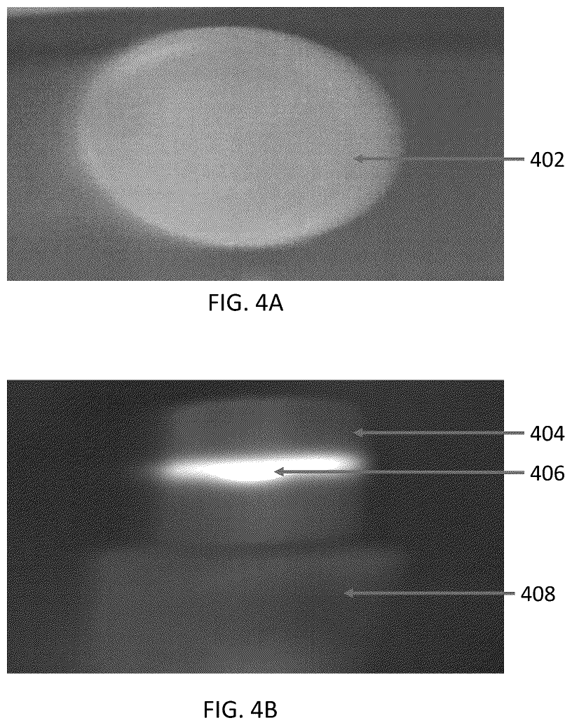

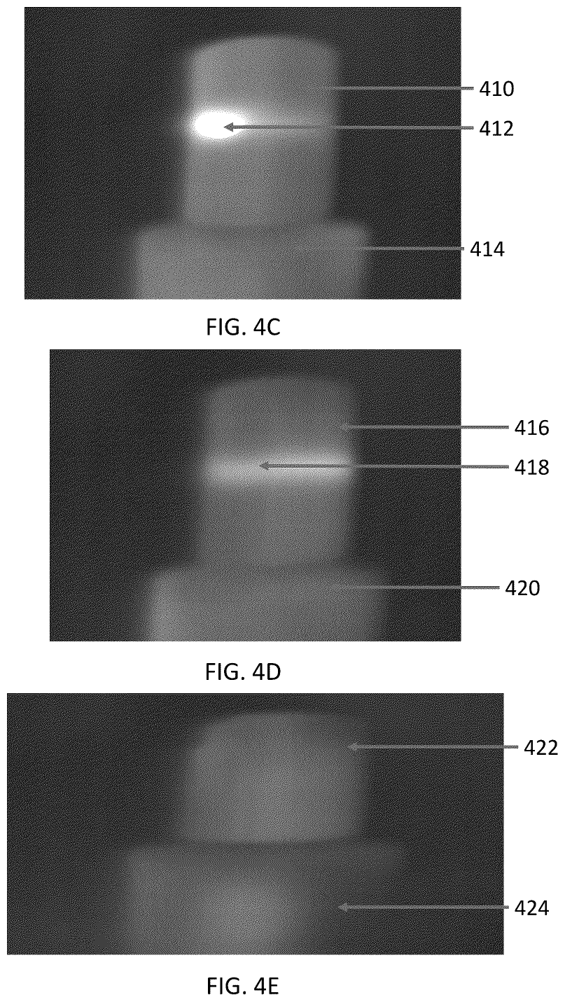

FIG. 4A is a representative thermal picture obtained when imaging an induction sealed container from above using thermal imaging. As seen from the picture, the induction seal is invisible when the container is imaged through the top of the cap 402.

Surprisingly, as seen in FIG. 4B, when the imaging was carried out through the side of the cap 404 on a sealed container 408, such that the induction seal 406 is imaged at an angle at to a transverse axis of the cap, the induction seal is readily visible.

Furthermore, the quality of the imaging is sufficient such that, when imaging is carried out through the side of the cap essentially perpendicularly to the plane of the induction seal, a defect in the sealing can be identified.

For example, in FIG. 4C, a defect resulting from a folded laminate 412 can be seen through the cap 410 on a sealed container 414, in FIG. 4D a defect resulting from insufficient heating of the laminate 418 can be seen can be seen through the cap 416 on a sealed container 420, and in FIG. 4E a defect resulting from lack of a laminate can be seen through the cap 422 on a sealed container 424.

### Example 2—Comparative Study of Imaging of Induction Sealed Containers Through the Top or Through the Side of the Cap

In the thermal images, white represents hot and black represents cold.

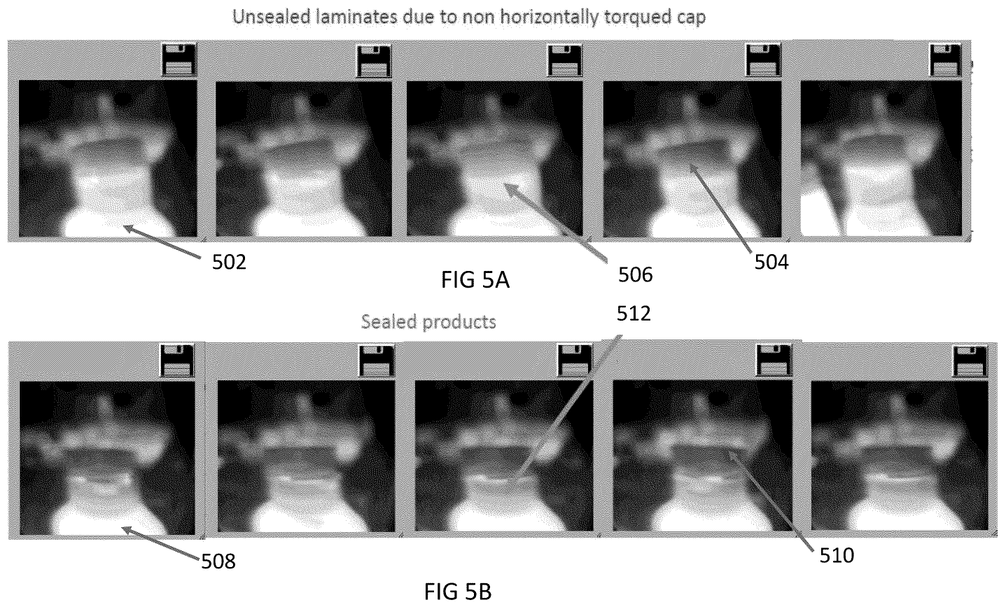

FIG. 5A shows representative pictures of an induction-sealed container with a compromised and/or defective induction seal (unsealed laminates due to non-horizontally torqued cap) as visible when imaging the induction seal through the cap of the container from a side thereof. The induction seal is imaged at an angle to a transverse axis of the cap.

For example, container 502 may include unsealed laminates due to non-horizontally torqued cap 504. The compromised and/or defective induction seal 506 is clearly visible, as is the skew cap, in the representative pictures.

FIG. 5B shows representative pictures of an induction-sealed container without a compromised and/or defective induction seal (sealed laminates due to horizontally torqued cap) as visible when imaging the induction seal through the cap of the container from a side thereof. The induction seal is imaged at an angle to a transverse axis of the cap.

For example, container 508 may include sealed laminates due to horizontally torqued cap 510. The induction seal 512 is not compromised and/or defective in the representative pictures.

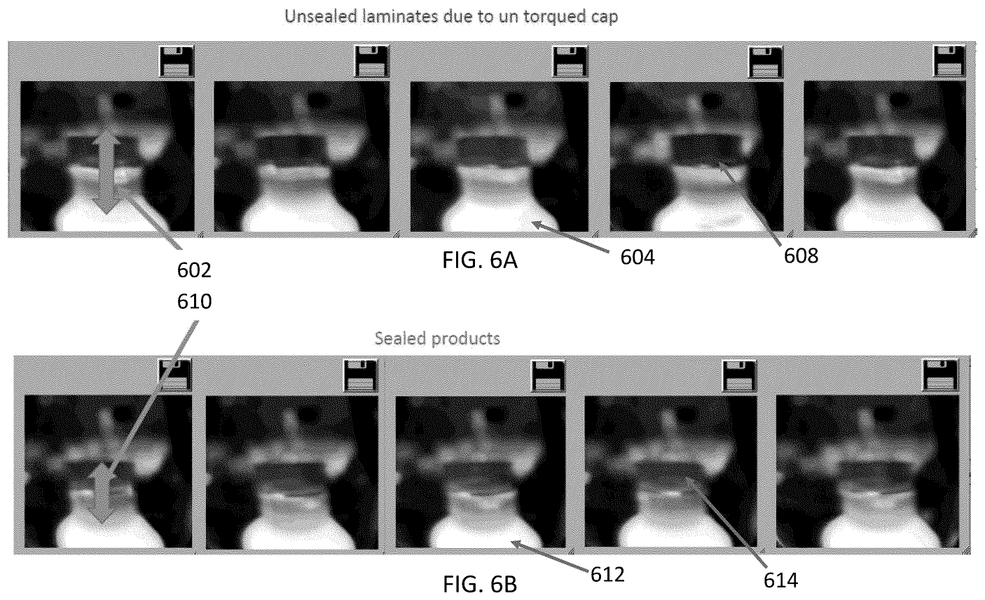

FIG. 6A shows representative pictures of an induction-sealed container with a compromised and/or defective induction seal (unsealed laminates due to non-horizontally torqued cap) as visible by cap height monitoring by thermal imaging of a cap and container from the side thereof.

For example, container 604 may include unsealed laminates due to non-horizontally torqued cap 608. The increased cap height 602 visible in the representative pictures is an indication of a compromised and/or defective induction seal.

FIG. 6B shows representative pictures of an induction-sealed container without a compromised and/or defective induction seal (sealed laminates due to horizontally torqued cap) as visible by cap height monitoring by thermal imaging of a cap and container from the side thereof.

For example, container 612 may include sealed laminates due to horizontally torqued cap 608. The acceptable cap height 602 visible in the representative pictures is an indication of an uncompromised and/or non-defective induction seal.

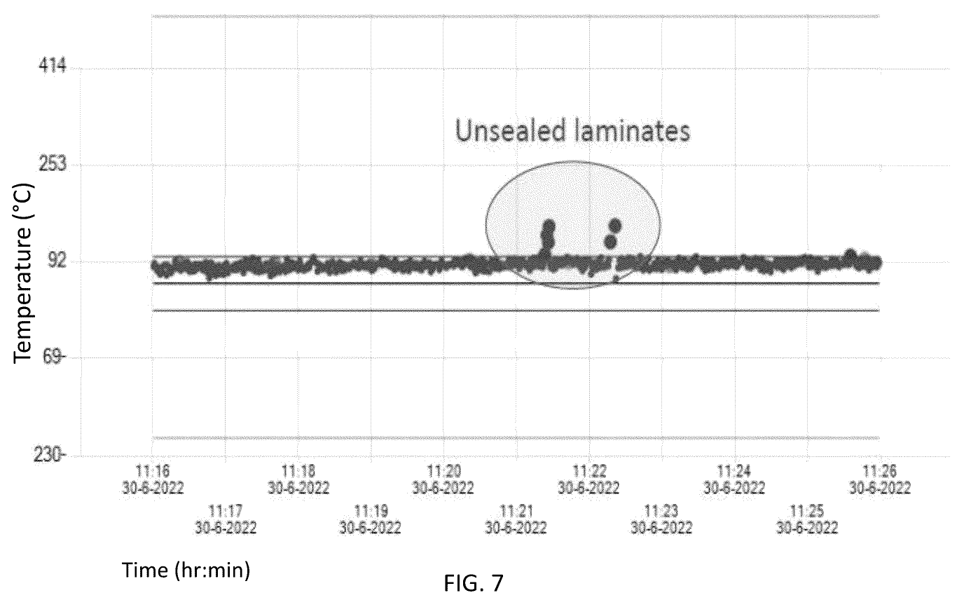

FIG. 7 shows a chart of side thermal camera statistical process controls results from thermal cap monitoring, according to some embodiments. Containers were monitored over a 10 min time period. Correctly sealed containers are shown in green while defective containers are shown in red. The chart shows that the temperature of the correctly sealed containers does not vary significantly. Of the 904 containers monitored, 8 were found to be defective (0.88%). This indicates that the induction process is well controlled, and that thermal monitoring is effective and efficient.

According to some embodiments, the packaging line may be monitored over a particular time period. Optionally, the time period may be days, hours, minutes, or seconds. Each possibility is a separate embodiment. According to some embodiments, the packaging line may be monitored for variations in temperature, thermal radiation, area, height, shape and/or any other output from the image processing algorithm. Each possibility is a separate embodiment.

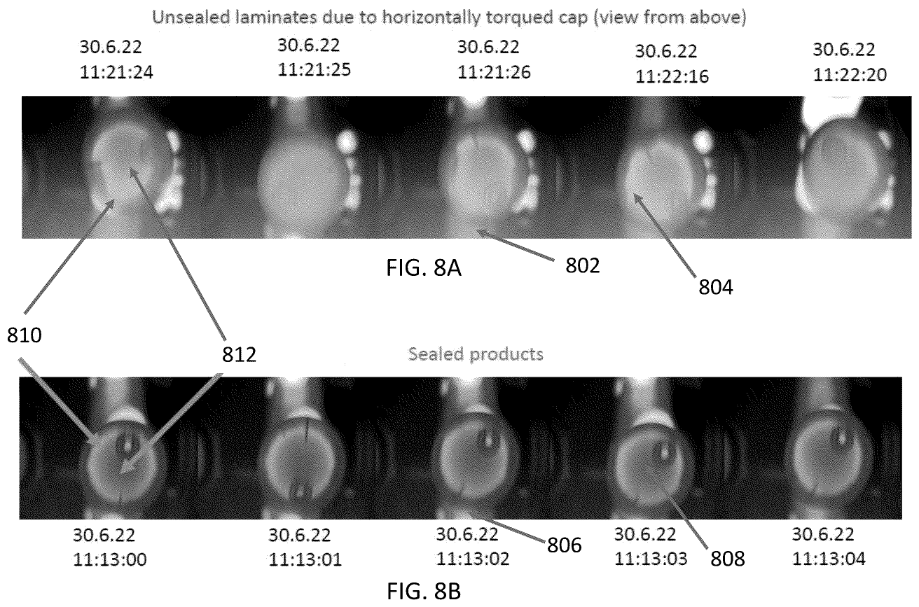

FIG. 8A shows representative pictures of an induction-sealed container with a compromised and/or defective induction seal (unsealed laminates due to non-horizontally torqued cap) as visible when imaging the induction seal through the cap of the container from the side thereof.

For example, container 802 may include unsealed laminates due to non-horizontally torqued cap 804. The compromised and/or defective induction seal is clearly visible as seen by the lack of thermal radiation contrast between the sealed ring 810 and the center ring 812 in the representative pictures.

FIG. 8B shows representative pictures of an induction-sealed container without a compromised and/or defective induction seal (sealed laminates due to horizontally torqued cap) as visible when imaging the induction seal through the cap of the container from the side thereof.

For example, container 806 may include sealed laminates due to horizontally torqued cap 808. The induction seal is not compromised and/or defective as seen by the thermal radiation contrast between the sealed ring 810 and the center ring 812 in the representative pictures.

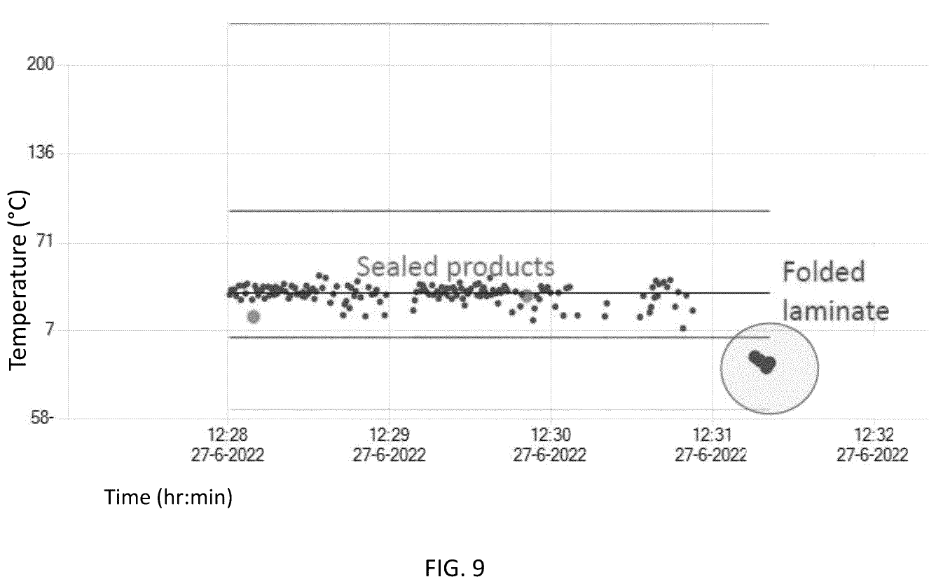

FIG. 9 shows a chart of top thermal camera statistical process controls results from thermal cap monitoring, according to some embodiments. Containers were monitored over a 3 min time period. The chart shows the results of comparison of the thermal radiation contrast between the sealed ring and the center ring. Correctly sealed containers are shown in green while defective containers are shown in red. The chart shows that the temperature of the correctly sealed containers does not vary significantly. Of the 77 containers monitored, 5 were found to be defective (2.82%). This indicates that the induction process is well controlled, and that thermal monitoring is effective and efficient.

According to some embodiments, the packaging line may be monitored over a particular time period. Optionally, the time period may be days, hours, minutes, or seconds. Each possibility is a separate embodiment. According to some embodiments, the packaging line may be monitored for variations in temperature, thermal radiation, area, height, shape and/or any other output from the image processing algorithm. Each possibility is a separate embodiment.

These results clearly indicate the surprising advantage of the herein disclosed system and method for evaluating sealing integrity of induction sealed containers.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising”, when used in this specification, specify the presence of stated features, integers, steps, operations, elements, or components, but do not preclude or rule out the presence or addition of one or more other features, integers, steps, operations, elements, components, or groups thereof.

Unless specifically stated otherwise, as apparent from the following discussions, it is appreciated that throughout the specification discussions utilizing terms such as “processing”, “computing”, “calculating”, “determining”, “estimating”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1.-33. (canceled)

34. A packaging line comprising:
a sealing station for induction sealing of containers; and
a thermal detector positioned at the sealing station, operative at a wavelength in the range of about 0.3 μm-about 14 μm and configured to image the containers after sealing thereof, wherein the thermal detector is configured to image the induction seal of the sealed containers, through a cap of the containers, such that the induction seal is imaged at an angle to a longitudinal or transverse axis of the container or cap.

35. The packaging line according to claim 34, further comprising a second thermal detector, wherein the first and second thermal detectors are positioned such that the induction seal of the sealed containers are imaged at an angle to the longitudinal or transverse axis of the container or cap from opposite sides thereof.

36. The packaging line according to claim 34, wherein the thermal detector is positioned above an upper cap of the containers, and wherein the packaging line further comprises one or more optical elements positioned such that the induction seal is imaged at an angle to the longitudinal or transverse axis of the container or cap from opposite sides thereof.

37. The packaging line according to claim 36, wherein the optical element comprises a movable IR mirror.

38. The packaging line according to claim 34, wherein the packaging line comprises a mechanism configured to rotate the sealed container and/or the detector, such that the induction seal is imaged at an angle to the longitudinal or transverse axis of the container or cap from opposite sides thereof.

39. The packaging line according to claim 34, wherein the thermal detector comprises a Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. or any combination thereof.

40. The packaging line according to claim 34, wherein the induction seal comprises a backing layer, a foil and a heat seal layer.

41. A packaging system comprising:
an imaging thermal detector operative at a wavelength in the range of about 2 μm-about 14 μm and configured to image the containers after sealing thereof, wherein the thermal detector is configured to image the induction seal of the sealed containers, through a cap of the containers, such that the induction seal is imaged at an angle to a longitudinal or transverse axis of the container or cap; and
a processor configured to:
apply big data analysis on one or more images obtained from the imaging of the container to determine a trend in the induction sealing performance, wherein the applying of the big data analysis comprises applying a machine learning algorithm, trained on a data set comprising a large plurality of images and a large plurality of labels associated with the large plurality of images, the large plurality of labels indicating an integrity of the induction seal of the sealed containers, and wherein the data set further comprises an indication regarding the cause of a reduced sealing efficiency associated with each of the large plurality of images having a compromised induction seal; and
provide an indication regarding a detected and/or predicted induction sealing deficiency based thereon.

42. The packaging system according to claim 41 further comprising a user interface for reporting actions taken and wherein the big data analysis further comprises taking into account the reported actions.

43. The packaging system according to claim 41, wherein the detected and/or predicted induction sealing deficiency is an operational defect selected from: missing induction seal or layer thereof, a defect in the induction seal, a bent induction seal or layer thereof, insufficient closing of the cap of the container, defect cap thread, sealing region contamination, defect sealing region or any combination thereof.

44. The packaging system according to claim 41, wherein the thermal detector comprises an Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. or any combination thereof.

45. A method for determining sealing integrity of induction-sealed containers, the method comprising:
imaging an induction container using a thermal detector operative at a wavelength in the range of about 2 μm-about 14 μm after sealing of the container by induction sealing;
wherein the imaging comprises imaging the induction seal of the container, through a cap of the container, such that the induction seal is imaged at an angle to a longitudinal or transverse axis of the container or cap.

46. The method according to claim 45, further comprising determining a sealing integrity of the container and/or to identifying an operational defect responsible for a reduced sealing efficiency by applying big data analysis on one or more images obtained from the imaging of the container.

47. The method according to claim 45, wherein the imaging comprises imaging the induction seal of the container from both sides of the induction seal.

48. The method according to claim 47, wherein the imaging from both sides of the induction seal comprises utilizing at least two thermal detectors.

49. The method according to claim 47, wherein the imaging from both sides of the induction seal comprises utilizing an optical element.

50. The method of claim 47, wherein the imaging from both sides of the induction seal comprises rotating the thermal detector or the container during imaging thereof.

51. The method according to claim 45, wherein the container is selected from the group consisting of: a canister, a blister package, a tube, a heat seal bag, a pouch, a sachet, a bottle, or any combination thereof.

52. The method according to claim 45, wherein the thermal detector is a bolometer or a semiconductor.

53. The method according to claim 52, wherein the thermal detector comprises a Indium Gallium Arsenide (InGaAs) detector, Indium Antimonide (InSb) detector, Mercury Cadmium Telluride (MCT) detector, Strained Layer Superlattice (SLS) detector, an amorphous silicon (a-Si) bolometer, Vanadium Oxide, Vox bolometer, microbolometer and/or any combination thereof. or any combination thereof
